(19) United States
(12) Patent Application Publication
(10) Pub. No.: US 2008/0237936 A1
(43) Pub. Date: Oct. 2, 2008

(54) Pattern forming mold and method and apparatus for forming a pattern

(75) Inventors: Dae-Jin PARK, Yeongsu-gu (KR); Jang-Kyum KIM, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/077,783

(22) Filed: Mar. 21, 2008

(30) Foreign Application Priority Data
Mar. 29, 2007 (KR) 10-2007-0030937

(51) Int. Cl. B29C 35/08; B29C 43/02; B29C 43/36

(52) U.S. Cl. 264/494; 425/470; 425/174.4

(57) ABSTRACT

A pattern forming mold according to an exemplary embodiment of the present invention includes a body, an effective pattern formed at the body, and a dummy pattern formed along a circumference of the effective pattern. The pattern forming mold may further include a light blocking unit formed along a circumference of the effective pattern at a region corresponding to the dummy pattern.

### CROSS-REFERENCE TO RELATED APPLICATION

This application claims priority to and the benefit of Korean Patent Application No. 10-2007-0030937 filed in the Korean Intellectual Property Office on Mar. 29, 2007, the entire contents of which are incorporated herein by reference.

### BACKGROUND OF THE INVENTION

(a) Field of the Invention The present invention relates to a pattern forming mold and a method and an apparatus for forming a pattern.

(b) Description of the Related Art

Liquid crystal displays, plasma display devices, field emission display devices, vacuum fluorescent displays, and organic light emitting devices are typical examples of recent display devices.

The size of display devices has been increased. In order to form a pattern in an active region of a substrate of large display devices, a step and repeat process is typically employed where the active region is subdivided and the pattern is formed repetitively in the subdivided active region.

In the step and repeat process, a total pattern is formed through multiple patterning processes, and therefore it may frequently cause a stitching error where undesirable lines occur at the boundary between patterns. Therefore, a technical solution that can prevent the stitching error during fabrication of a large area display panel is important. In addition, since the step and repeat process that involves multiple patterning processes may result in an increase of an entire process time, the yield of display panels may be substantially improved if the process time is reduced. In addition, it is required to improve accuracy of pattern forming so as to improve reliability of display devices.

### SUMMARY OF THE INVENTION

The present invention has been made in an effort to provide a pattern forming mold and a method and an apparatus for forming a pattern having advantages of preventing stitching error that may occur on a display panel in a step and repeat process, forming a precise pattern on a substrate, and reducing a pattern forming time so as to reduce an entire process time.

A pattern forming mold according to an exemplary embodiment of the present invention includes a body, an effective pattern formed at the body, and a dummy pattern formed along a circumference of the effective pattern.

The exemplary pattern forming mold may further include a light blocking unit formed along a circumference of the effective pattern at a region corresponding to the dummy pattern.

The body may include a first side and a second side that is opposite to the first side, and the effective pattern and the dummy pattern may be formed on the first side while the light blocking unit may be formed on the second side.

The dummy pattern may include a boundary wall that forms a space outside the effective pattern.

A width of the boundary wall may be in a range of 300 μm to 800 μm.

The effective pattern may include a main pattern and an auxiliary pattern formed exterior to the main pattern. The auxiliary pattern may be an incomplete pattern such that a complete pattern is formed together with another auxiliary pattern.

An exemplary apparatus for forming a pattern according to an exemplary embodiment of the present invention may include the above described pattern forming mold according to an exemplary embodiment of the present invention, a supporting plate supporting a substrate provided with a material layer where the pattern is formed by the pattern forming mold, and a pressure roller that presses the pattern forming mold for contacting the material layer.

In the exemplary apparatus for forming a pattern, the pattern forming mold and the pressure roller may be provided as a plurality, and a plurality of pressure rollers that may be disposed corresponding to a plurality of pattern forming molds.

The exemplary apparatus for forming a pattern may further include a plurality of light source units respectively corresponding to each of the plurality of pattern forming molds to radiate light toward the pattern forming molds.

An exemplary method for forming a pattern according to an embodiment of the present invention includes forming a pattern by an imprint lithography process using a pattern forming mold having an effective pattern, a dummy pattern formed along a circumference of the effective pattern, and a light blocking unit formed at a region corresponding to the dummy pattern. The exemplary method may include locating a substrate on a supporting plate, the substrate being formed with a material layer, forming resin on the material layer, contacting and pressing the pattern forming mold to the resin to fill in the effective pattern of the mold, and hardening the resin in the effective pattern of the mold by applying light thereto, wherein the light is radiated toward the effective pattern region and is blocked from radiating into the dummy pattern region by the light blocking unit.

The effective pattern and the dummy pattern may be formed at a first side of the pattern forming mold, and the light blocking unit may be formed at a second side thereof.

The dummy pattern may include a boundary wall that forms a space exterior to the effective pattern.

The pattern forming mold may include a first pattern forming mold and a second pattern forming mold, and the material layer formed on the substrate may include first and second main regions that are adjacent to each other. In this case, the first pattern forming mold patterns the first main region and the second pattern forming mold patterns the second main region.

An auxiliary region may be formed between the first and second main regions. A pattern formed at the auxiliary region may be cooperatively formed as a combination of a first pattern formed by the auxiliary pattern of the first pattern forming mold and a second pattern formed by the auxiliary pattern of the second pattern forming mold.

In the auxiliary region, the first pattern may gradually decrease and the second pattern may gradually increase, in a direction from the first main region to the second main region.

The first and second main regions may be provided as a plurality of pairs of regions. The first pattern forming mold may pattern a pair of a first main region and an auxiliary region, and the second pattern forming mold may simultaneously pattern a pair of a second main region and an auxiliary region.

A first pressure roller may be provided to the first pattern forming mold and a second pressure roller may be provided to the second pattern forming mold such that the first and second rollers respectively press the first and second pattern forming molds.

The first pattern forming mold may be radiated by a light from a first light source unit, and the second pattern forming mold may be radiated by a light from a second light source unit.

### BRIEF DESCRIPTION OF THE DRAWINGS

FIG. 1 is a partial cutaway perspective view of a display panel manufacturing apparatus including a pattern forming mold according to an exemplary embodiment of the present invention.

FIG. 2 shows a cross-sectional view of FIG. 1 along line II-II and the pattern forming mold shown in FIG. 1.

FIGS. 3A to 3C are drawings for visualizing a gradual imprint method.

FIG. 4 is a top plan view of a display panel manufacturing apparatus, and shows a plurality of pressure rollers thereof.

FIG. 5 is a perspective view of a display panel manufacturing apparatus, and shows a plurality of light source units thereof.

FIG. 6 shows hardening of resin by the light source units.

FIG. 7 is a cross-sectional view of a pattern forming mold according to another exemplary embodiment of the present invention.

FIG. 8A to FIG. 8G show respective steps of imprint lithography according to an exemplary embodiment of the present invention.

### DETAILED DESCRIPTION OF THE EMBODIMENTS

With reference to the accompanying drawings, the present invention will be described in order for those skilled in the art to be able to implement the invention. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification

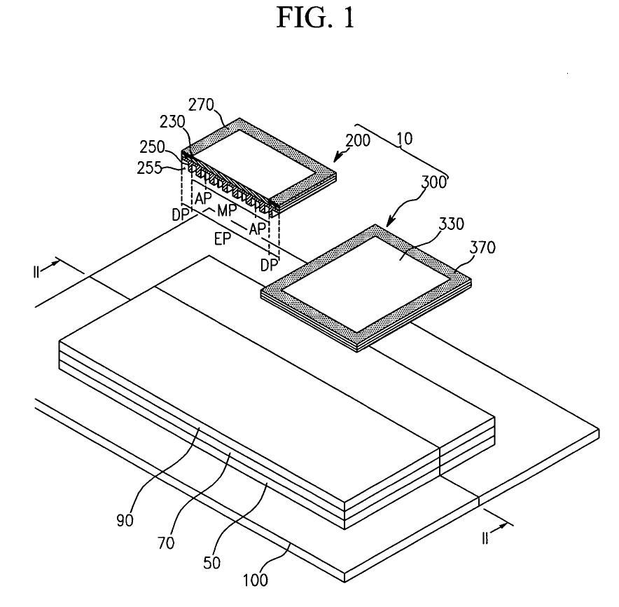

FIG. 1 is a partially cutaway perspective view of a display panel manufacturing apparatus including a pattern forming mold (hereinafter simply called a mold) 10 according to an exemplary embodiment of the present invention. An imprint lithography process may be performed with the display panel manufacturing apparatus, and various patterns such as a semiconductor pattern, an insulating layer pattern, and a metal pattern may be formed by such an imprint lithography process. That is, it should be understood that the mold 10 according to an exemplary embodiment of the present invention may be applied to various patterning processes and is not limited to a single specific pattern.

As shown in FIG. 1, the display panel manufacturing apparatus includes a supporting plate 100 and the mold 10. The mold 10 of the present exemplary embodiment includes a first mold 200 and a second mold 300. It should be understood that the mold 10 may be employed as a plurality of molds for fabrication of a large area display panel. The imprint process of such a large area display panel may be performed by a step and repeat method. The imprint process of a display panel of less than a certain size may be performed by using a single mode without employing a step and repeat method.

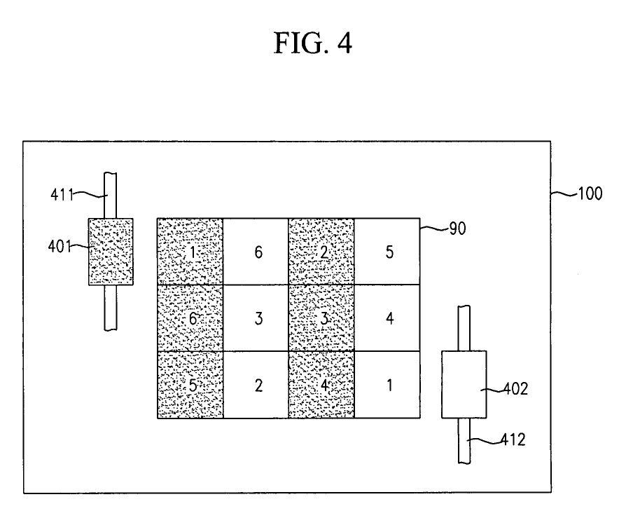

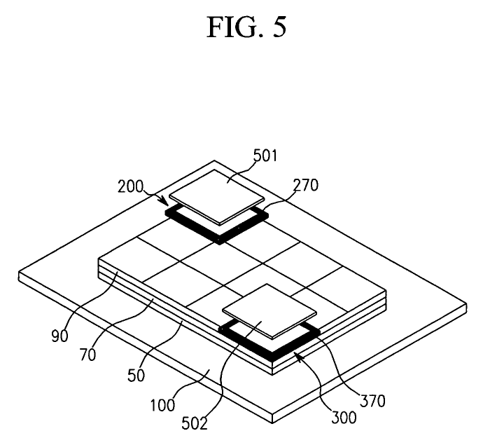

The display panel manufacturing apparatus may further include pressure rollers 401 and 402 (refer to FIG. 4) and light source units 501 and 502 (refer to FIG. 5). The pressure rollers 401 and 402 and the light source units 501 and 502 are later described with reference to FIG. 4 to FIG. 6.

The supporting plate 100 supports a substrate 50. Although the supporting plate 100 has a rectangular planar shape according to the present exemplary embodiment, it should be understood that the supporting plate 100 may have various shapes. A slip preventing member (not shown) may be employed in the supporting plate 100 such that the substrate 50 may be stably supported by the supporting plate 100 without slippage.

The substrate 50 is coated with a material layer 70 where a pattern will be formed. The material layer 70 is formed in a predetermined pattern by using the pattern forming mold 10 and a resin layer 90 formed above the material layer 70. Various types of layers such as an insulating layer, an amorphous silicon layer, and a metal layer may be used as the material layer 70 formed on the substrate 50.

Referring back to FIG. 1, the mold 10 according to an exemplary embodiment of the present invention includes a pair of molds, i.e., the first mold 200 and the second mold 300 described above. The first and second molds 200 and 300 includes bodies 230 and 330, effective patterns EP formed on a first side of the bodies 230 and 330, and light blocking units 270 and 370 formed on a second side (which is opposite to the first side) of the bodies 230 and 330, respectively. In addition, the first mold 200 and the second mold 300 further include a dummy pattern DP formed along a circumference of the effective pattern EP, respectively. The dummy pattern DP is formed at regions corresponding to the light blocking units 270 and 370.

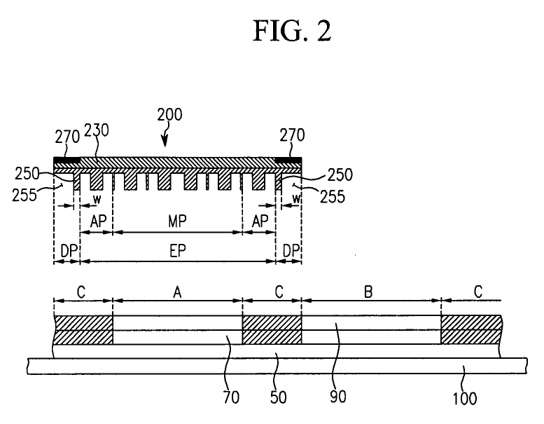

The effective pattern EP includes a main pattern MP and an auxiliary pattern AP, and has a shape corresponding to a pattern that will be formed at the material layer 70. The auxiliary pattern AP is formed exterior to the main pattern MP. The auxiliary patterns AP of the first and second molds 200 and 300 cooperatively form a pattern at an auxiliary region C (refer to FIG. 2) of the material layer 70.

The effective pattern EP and the dummy pattern DP at a circumference thereof may be formed by an imprint process using a master pattern corresponding thereto.

The first mold 200 and the second mold 300 may have different shapes of the effective pattern EP and the dummy pattern DP, and they may also have the same shapes of the effective pattern EP and the dummy pattern DP. In either case, the auxiliary patterns AP of the first mold 200 and the second mold 300 are formed in different shapes since they may cooperatively form the pattern at the auxiliary region C of the material layer 70.

Alternatively, a pattern may be formed on a large area substrate 50 by multiple imprinting using a single mold (for example, the first mold 200). In this case, the single mold 200 is repeatedly used in the imprint, and opposite sides of the auxiliary pattern AP of the single mode 200 are shaped so as to cooperatively form a pattern. That is, when the auxiliary pattern AP of the single mold 200 is divided into four regions (i.e., upper, lower, left, and right regions) with the main pattern MP at their center, the upper and lower regions of the auxiliary pattern have cooperative structures, and the left and right regions of the auxiliary pattern have cooperative structures.

The dummy patterns DP are formed along circumferences of the effective pattern EP at respective first sides of the bodies 230 and 330 of the first and second molds 200 and 300. The dummy pattern DP includes a boundary wall 250 that forms a space 255 outside the effective pattern EP. A width w (refer to FIG. 2) of the boundary wall 250 may be formed in a range of 300 μm to 800 μm.

Although not shown in FIG. 1, the second mold 300 also has a boundary wall that is the same as or similar to the boundary wall 250 of the first mold 200.

When the mold 10 having the effective pattern EP and the dummy pattern DP is located on and pressed onto the resin layer 90 coated on the material layer 70, the resin fills the space formed at the effective pattern EP. Thereafter, a pattern corresponding to the effective pattern EP is formed at the material layer 70 by consecutively performing hardening of the resin, etching the material layer 70, and stripping the hardened resin.

When the first and second molds 200 and 300 are pressed, the boundary wall 250 of the dummy pattern DP pushes the extra resin outside the effective pattern EP, and a bottom end in the drawing of the boundary wall 250 makes contact with the material layer 70. The resin that is pushed out by the boundary wall 250 is located in the space 255 of the dummy pattern DP, and the light for hardening the resin does not reach the space 255 since the space 255 is blocked by the light blocking units 270 and 370.

The light blocking units 270 and 370 are formed along edges of respective second sides of the bodies 230 and 330 of the first and second molds 200 and 300. In more detail, the light blocking units 270 and 370 are formed at a position corresponding to the periphery of the effective pattern EP, that is, a position corresponding to a region where the dummy pattern DP is formed. In the width direction, one end of the light blocking units 270 and 370 is located at a position where the effective pattern EP ends and the dummy pattern DP starts at the same time, and another end thereof is located at a position where the dummy pattern DP ends. Alternatively, one end of the light blocking units 270 and 370 may be located at a position on the second side that corresponds to the boundary wall 250.

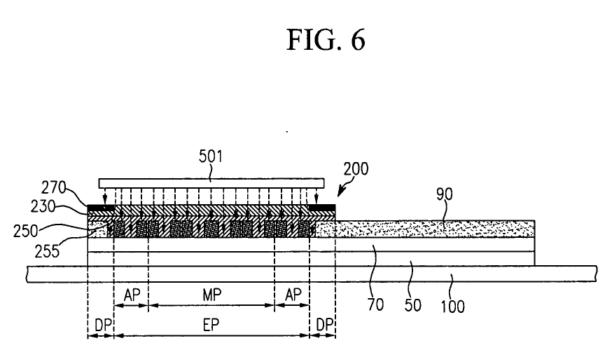

Such light blocking units 270 and 370 block light from entering the dummy pattern DP during the light hardening process. Even if the light may reach the dummy pattern DP by refraction, the light can only reach the boundary wall 250 having a certain width and does not reach the space 255 of the dummy pattern DP. This will be described later with reference to FIG. 6, in further detail.

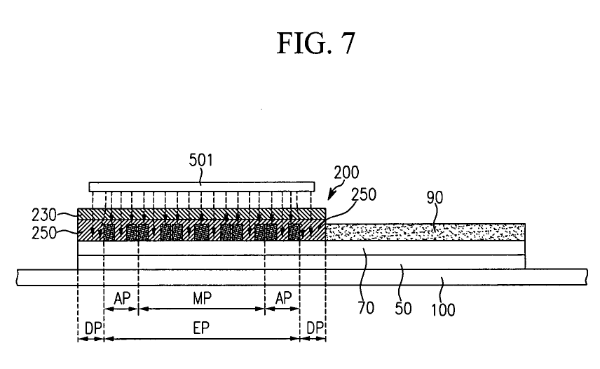

Alternatively, first and second molds 200 and 300, respectively, may not include the light blocking units 270 and 370, according another exemplary embodiment (refer to FIG. 7).

FIG. 2 shows a cross-sectional view of FIG. 1 along line II-II and the first mold 200 shown in FIG. 1. As described above, the width w of the boundary wall 250 of the first mold 200 is formed in the range of 300 μm to 800 μm. A boundary wall (not shown) of the second mold 300 is also formed with a width in the range of 300 μm to 800 μm.

Herein, a pair of molds (i.e., the first and second molds 200 and 300) are employed for a successive imprint process. However, it may be understood that such a configuration is a mere exemplification, and a single mold or a greater number of molds may be employed depending on a particular display panel design scheme.

During the successive imprint process, the first and second molds 200 and 300 are repeatedly used for the patterning process, and the number of repetitions may be variously determined depending on the size of the substrate 50 and of the first and second molds 200 and 300. When the pattern is formed by using the successive imprint process, the auxiliary region C is provided at a neighboring region of the patterns formed by the first and second molds 200 and 300, and accordingly the stitching error may be prevented. Hereinafter, the successive imprint process is described in further detail.

The material layer 70 includes the first main region A, a second main region B, and the auxiliary region C. They are regions obtained by dividing the region where the pattern is formed by the first and second molds 200 and 300. The material layer 70 is coated with the resin layer 90.

During the successive imprint process, the first mold 200 forms a first pattern at the first main region A and the auxiliary region C of the material layer 70, and subsequently, the second mold 300 forms a second pattern on the second main region B and the auxiliary region C of the material layer 70. The above-mentioned patterning process is repeated such that the pattern is formed at all other regions of the material layer 70.

The pattern formed at the auxiliary region C is formed by cooperative patterning of the first mold 200 and the second mold 300. In other words, the pattern formed at the auxiliary region C is formed as a combination of the pattern formed by the auxiliary pattern AP of the first mold 200 and the auxiliary pattern AP of the second mold 300.

For example, it may be that, in the auxiliary region C, the pattern formed by the auxiliary pattern AP of the first mold 200 gradually decrease at a neighboring area between the first main region A and the auxiliary region C in a direction toward the second main region B, and the pattern formed by the auxiliary pattern AP of the second mold 300 gradually increase in the same direction.

As described above, when the material layer 70 is patterned by the successive imprint method, the pattern formed by the first mold 200 and the pattern formed by the second mold 300 are gradually combined at the auxiliary region C, and thereby a stitching error may be prevented.

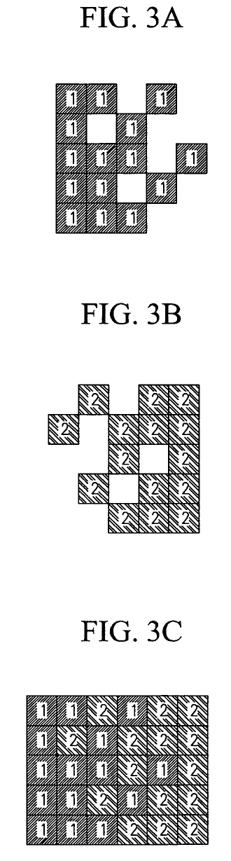

FIGS. 3A to 3C are drawings for visualizing a successive imprint method, and they show the auxiliary region C of the material layer 70 shown in FIG. 2. FIG. 3A shows a pattern formed by the first mold 200, and FIG. 3B shows a pattern formed by the second mold 300. FIG. 3C shows a completed pattern formed by self-aligned stitching in the auxiliary region C as a combination of the pattern from the first mold 200 and the pattern from the second mold 300.

As shown in FIG. 3C, the patterns formed by the first and second molds 200 and 300 are combined with each other at the neighboring region. Therefore, according to the present exemplary embodiment, the neighboring region may become free from stitching error gaps.

FIG. 4 is a top plan view of a display panel manufacturing apparatus and shows a plurality of pressure rollers 401 and 402 thereof. Referring to FIG. 4 as well as FIGS. 1 and 2, the display panel manufacturing apparatus further includes pressure rollers 401 and 402 in addition to the supporting plate 100 and the first and second molds 200 and 300. Herein, although the exemplary display panel manufacturing apparatus is provided with two pressure rollers 401 and 402, it may be understood that a greater number of pressure rollers may be employed.

When the successive imprint process is performed with the two molds, the first and second molds may simultaneously imprint the resin layer 90 along opposite directions starting from opposite sides. That is, the first mold 200 may sequentially move and imprint the shaded regions of the resin layer 90, and simultaneously, the second mold 300 may sequentially imprint the remaining regions.

The two pressure rollers 401 and 402 press the first mold and the second mold respectively. The shaded pressure roller 401 moves in accordance with and presses the first mold when the first mold contacts the resin layer 90, and the other pressure roller 402 moves in accordance with and presses the second mold when the second mold contacts the resin layer 90.

The pressure rollers 401 and 402 press the first and second molds 200 and 300 by receiving driving force from and being rotated by shafts 411 and 412, and they move in a path corresponding to the first and second molds 200 and 300 using a moving apparatus (not shown). As described above, the imprint process time may be decreased since the two molds contact the resin layer 90 almost simultaneously and the two pressure rollers 401 and 402 simultaneously press the two molds. Accordingly, an entire process time may be reduced and productivity of a display panel may be improved.

FIG. 5 is a perspective view of a display panel manufacturing apparatus and shows a plurality of light source units 501 and 502 thereof. As shown in FIG. 5, although the display panel manufacturing apparatus includes two light source units 501 and 502, it may be understood that a greater number of light source units may be employed.

The two light source units 501 and 502 are provided with a moving apparatus (not shown) so as to move in accordance with the first and second molds 200 and 300. After the pressure rollers 401 and 401 shown in FIG. 4 press the first and second molds 200 and 300, the light source units 501 and 502 radiate light on the first and second molds 200 and 300 such that the resin may become hardened, i.e., cured. The light from the light source unit 501 and 502 is radiated toward the effective pattern EP (refer to FIG. 1) of the first and second molds 200 and 300, and the light outside the effective pattern EP is blocked by the light blocking units 270 and 370.

Since the two light source units 501 and 502 above the first and second molds 200 and 300 simultaneously enable the resin curing, the process time for display panel manufacturing is shortened.

FIG. 6 shows cure hardening of resin by the light source units. Referring to FIG. 6, the first mold 200 presses the resin layer 90 formed on the substrate 50. At this time, the above-mentioned pressure roller 401 (refer to FIG. 4) may be used.

When the first mold 200 presses the resin layer 90, the resin fills a space formed in the effective pattern EP. The boundary wall 250 of the dummy pattern DP pushes the extra resin out of the effective pattern EP to the space 255 of the dummy pattern DP.

Subsequently, hardening of the resin filling the effective pattern EP is performed, and the light source unit 501 is used for this purpose. When the display panel is of a large area, a plurality of light source units 501 may be simultaneously used so as to reduce the process time for hardening the resin.

The light radiated from the light source unit 501 to the first mold 200 in the arrow direction is incident on the effective pattern EP region, and the light outside the effective pattern EP is blocked by the light blocking unit 270. Therefore, the resin in the space 255 of the dummy pattern DP is not hardened, which enables easy removal, and accordingly hardening of excess resin in an undesired pattern may be prevented.

Even if the light from the light source unit 501 reaches the dummy pattern DP by refraction, it can only reach the boundary wall 250 that has a width of 300 μm to 800 μm and does not reach the resin in the space 255 of the dummy pattern DP. The width of the boundary wall 250 may be determined by taking into account various factors, such as a maximum refraction of the light from the light source unit 501.

On the other hand, it is possible that the light blocking unit 270 (refer to FIG. 6) is not formed in the first mold 200 as shown in FIG. 7. In this case, the width of the boundary wall 250 may be made larger than 800 μm. Furthermore, the dummy pattern DP may be made entirely of the boundary wall 250 such that the space 255 (refer to FIG. 6) is not formed. When the dummy pattern DP is the entire boundary wall 250, the remaining resin after filling the effective pattern EP extends to the exterior of the boundary wall 250, that is, to the outside of the first mold 200, and the light from the light source unit 501 reaches only the effective pattern EP and the boundary wall 250 of the dummy pattern DP. Therefore, the light does not reach the resin pushed out beyond the exterior of the boundary wall 250.

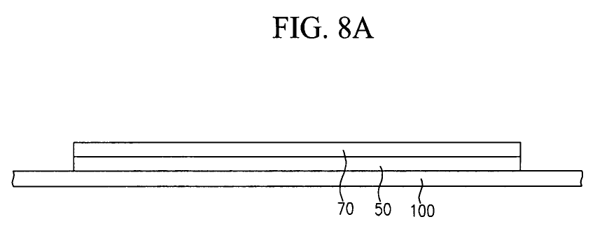

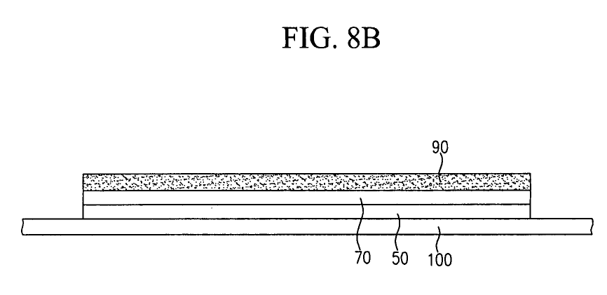

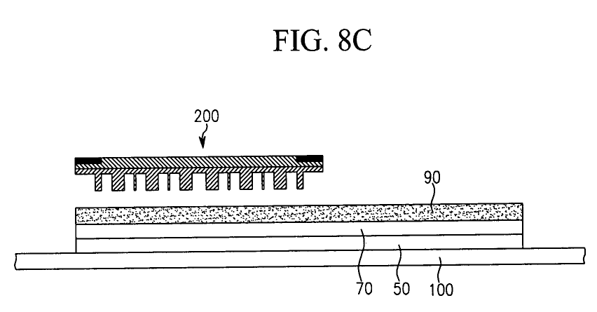

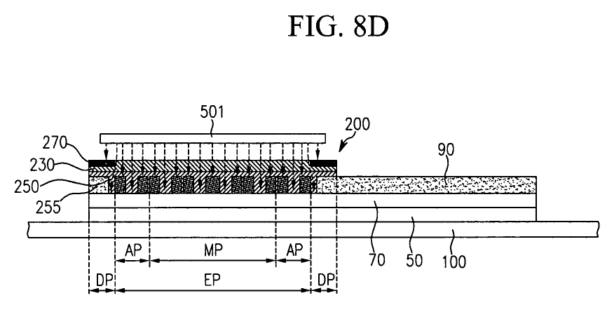

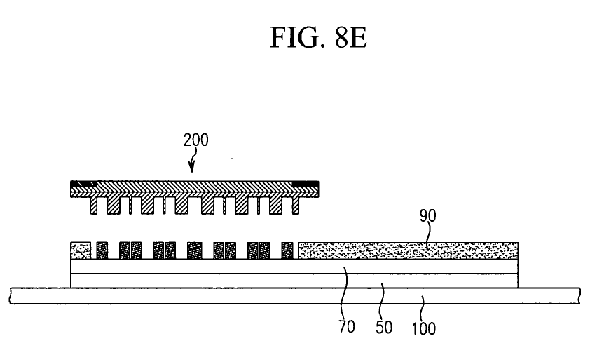

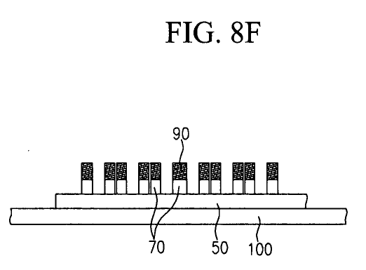

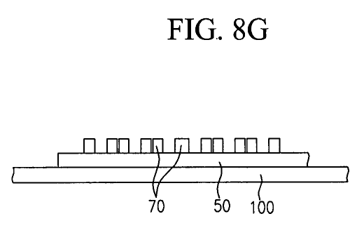

FIG. 8A to FIG. 8G show steps of imprint lithography according to an exemplary embodiment of the present invention. Hereinafter, a method for forming a pattern by an imprint lithography process is described in detail with reference to FIGS. 8A to 8G as well as FIGS. 1, 2, 4, and 5.

Firstly, as shown in FIG. 8A, the substrate 50 and the material layer 70 where the pattern is to be formed are formed on the supporting plate 100. A slip preventing member (not shown) may be formed on the supporting plate 100 so as to prevent slippage of the substrate 50.

Then, the resin layer 90 is coated on the material layer 70 as shown in FIG. 8B. Subsequently as shown in FIG. 8C, the first mold 200 is located on the resin layer 90, and then the first mold 200 is pressed by a pressing means such as a pressure roller 401. At this time, the effective pattern EP of the first mold 200 is filled with the resin, and the boundary wall 250 of the dummy pattern DP pushes out the extra resin remaining after filling the effective pattern EP to the space 255 of the dummy pattern DP.

Thereafter, the resin located in the effective pattern EP of the first mold 200 is hardened by using the light source unit 501 disposed above the first mold 200 (refer to FIG. 8D). At this time, the light from the light source unit 501 is radiated toward the effective pattern EP region, and the light outside the effective pattern EP region is blocked by the light blocking unit 270.

Even if the light is refracted at the body 230 of the first mold 200, the light can only reach the boundary wall of the dummy pattern DP, and does not reach the resin in the space 255 of the dummy pattern DP. Therefore, the resin in the space 255 of the dummy pattern DP is not hardened.

If the resin in the dummy pattern DP is hardened, the material layer 70 under the hardened resin may not etch properly, and an undesirable pattern may be formed. This may cause critical damage to the quality of the display panel.

Subsequently, the first mold 200 is separated from the resin layer 90 as shown in FIG. 8E. Then, the second mold 300 is located on the resin layer 90 at a position that is not hardened, and then the above-mentioned pressing process is performed. At this time, the un-hardened resin floats to fill the main pattern of the second mold 300. After that, the above-mention light hardening process is performed. For convenience of description, the process using the second mold is not shown in the drawings since it is the same as the process using the first mold.

After repeating the pressing of the first and second molds and light hardening of the pressed region over the entire region of the substrate 50, non-hardened resin is removed. After that, an exposed portion of the material layer 70 is removed by etching, as shown in FIG. 8F.

Subsequently, the hardened resin is removed by a strip process as shown in FIG. 8G, and accordingly, the material layer 70 may be patterned into a desired pattern on the substrate 50.

As described above, according to a display panel manufacturing apparatus of the present exemplary embodiment, hardening of resin outside the effective pattern region may be prevented, and accordingly a more precise pattern may be formed on a substrate.

According to an exemplary embodiment of the present invention, a dummy pattern and/or a light blocking unit are formed in a mold, hardening of resin outside the effective pattern of the mold is prevented, and accordingly an undesirable pattern is prevented from being formed on the substrate.

In addition, according to an exemplary embodiment of the present invention, a plurality of pressure rollers and a plurality of light source units are employed. Therefore, the process time for the imprint lithography can be reduced, and furthermore, the total manufacturing time of the display panel is reduced such that the productivity of the display panel is improved.

In addition, according to an exemplary embodiment of the present invention, for a large area display panel that is manufactured by a step and repeat method, the patterning is performed by a successive imprint method, and accordingly the stitching error that may occur at neighboring regions may be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A pattern forming mold, comprising:
a body;
an effective pattern formed at the body; and
a dummy pattern formed along a circumference of the effective pattern.

2. The pattern forming mold of claim 1, further comprising a light blocking unit formed along a circumference of the effective pattern at a region corresponding to the dummy pattern.

3. The pattern forming mold of claim 2, wherein:
the body comprises a first side and a second side that is opposite to the first side; and
the effective pattern and the dummy pattern are formed on the first side and the light blocking unit is formed on the second side.

4. The pattern forming mold of claim 3, wherein the dummy pattern comprises a boundary wall that forms a space outside the effective pattern.

5. The pattern forming mold of claim 4, wherein a width of the boundary wall is in a range of 300 μm to 800 μm.

6. The pattern forming mold of claim 1, wherein the effective pattern comprises a main pattern and an auxiliary pattern formed exterior to the main pattern.

7. The pattern forming mold of claim 6, wherein the auxiliary pattern is an incomplete pattern such that a complete pattern is formed together with another auxiliary pattern.

8. An apparatus for forming a pattern, comprising:
a pattern forming mold comprising a body, an effective pattern formed at the body and a dummy pattern formed along a circumference of the effective pattern;
a supporting plate supporting a substrate provided with a material layer where the pattern is formed by the pattern forming mold; and
a pressure roller that presses the pattern forming mold to contact the material layer.

9. The apparatus of claim 8, wherein:
the pattern forming mold and the pressure roller are each provided as a plurality; and
the plurality of pressure rollers are disposed corresponding to the plurality of pattern forming molds.

10. The apparatus of claim 9, further comprising a plurality of light source units that respectively correspond to the plurality of pattern forming molds and radiate light toward the pattern forming molds.

11. A method for forming a pattern, by an imprint lithography process using a pattern forming mold having an effective pattern, a dummy pattern formed along a circumference of the effective pattern, and a light blocking unit formed at a region corresponding to the dummy pattern, the method comprising:
locating a substrate on a supporting plate, the substrate being formed with a material layer;
forming resin on the material layer;
contacting and pressing the pattern forming mold to the resin; and
hardening the resin that fills the effective pattern of the pattern forming mold by applying light thereto,
wherein the light used in the hardening of the resin is radiated toward the effective pattern region, and is blocked from radiating into the dummy pattern region by the light blocking unit.

12. The method of claim 11, wherein the effective pattern and the dummy pattern are formed at a first side of the pattern forming mold and the light blocking unit is formed at a second side thereof.

13. The method of claim 12, wherein the dummy pattern comprises a boundary wall that forms a space exterior to the effective pattern.

14. The method of claim 13, wherein:
the pattern forming mold comprises a first pattern forming mold and a second pattern forming mold; and
the material layer formed on the substrate comprises first and second main regions that are adjacent to each other,
wherein the first pattern forming mold patterns the first main region and the second pattern forming mold patterns the second main region.

15. The method of claim 14, wherein:
an auxiliary region is formed between the first and second main regions; and
a pattern formed at the auxiliary region is cooperatively formed as a combination of a first pattern formed by the auxiliary pattern of the first pattern forming mold and a second pattern formed by the auxiliary pattern of the second pattern forming mold.

16. The method of claim 15, wherein, in the auxiliary region, the first pattern gradually decrease and the second pattern gradually increase, in a direction from the first main region to the second main region.

17. The method of claim 14, wherein a first pressure roller is provided to the first pattern forming mold and a second pressure roller is provided to the second pattern forming mold such that the first and second rollers respectively press the first and second pattern forming molds.

18. The method of claim 17, wherein the first pattern forming mold is radiated by a light from a first light source unit, and the second pattern forming mold is radiated by a light from a second light source unit.
